(19) United States
(12) Patent Application Publication
(10) Pub. No.: US 2024/0116789 A1
(43) Pub. Date: Apr. 11, 2024

(54) REMOVAL OF CHELATED IRON FROM PRODUCED WATER

(71) Applicant: CONOCOPHILLIPS COMPANY, Houston, TX (US)

(72) Inventors: Jonathan KIESEWETTER, Houston, TX (US); Ramesh SHARMA, Houston, TX (US); Paul CARMAN, Houston, TX (US)

(73) Assignee: CONOCOPHILLIPS COMPANY, Houston, TX (US)

(21) Appl. No.: 18/481,977

(22) Filed: Oct. 5, 2023

Related U.S. Application Data
(60) Provisional application No. 63/378,586, filed on Oct. 6, 2022.

(51) Int. Cl. C02F 1/72; C02F 1/56; C02F 1/66; C02F 1/68; C09K 8/528; E21B 43/28; E21B 43/34

(52) U.S. Cl. CPC C02F 1/722; C02F 1/56; C02F 1/66; C02F 1/683; C02F 1/72; C09K 8/528; E21B 43/283; E21B 43/35; C02F 2103/365; C02F 2305/023

(57) ABSTRACT

Method of decomposing high molecular weight polymer downhole to prevent chelation of iron by residual high molecular weight polymer thereby producing flowback without iron contamination as chelated iron. A secondary method is also described to treat iron chelated produced water with oxidants at surface conditions, utilizing aluminum electrolytes, specifically low basicity polyaluminum chloride, to either co-precipitate residual polymer and bound iron, or to substitute chelated iron with aluminum in the polymer-metal complex, resulting in liberating of iron to enable neutral pH oxidation and removal by precipitation, coagulation, flocculation and physical separation. The produced water with removed iron can be then stored or re-used for other oilfield applications.

### PRIOR RELATED APPLICATIONS

This application claims priority to U.S. Ser. No. 63/378,586, filed Oct. 6, 2022, and incorporated by reference in its entirety for all purposes.

### FEDERALLY SPONSORED RESEARCH STATEMENT

Not applicable.

### FIELD OF THE DISCLOSURE

The disclosure generally relates to methods of cleaning produced water for reuse.

### BACKGROUND OF THE DISCLOSURE

One of the biggest shifts in the U.S. oil and gas industry over the last decade is the combined use of horizontal drilling and hydraulic fracturing to produce hydrocarbons from shale rock. As this segment of the unconventional industry has progressed, the cost of production from shale operations has steadily decreased each year, but associated water costs have inversely increased. The increase in costs is partially due to the use of larger and larger volumes of water during well development as lateral lengths, staging and proppant load has increased. Not only does this additional water cost more to source (from primarily aquifers or surface sources), but flowback volumes requiring disposal have also increased.

As an example, ˜75,000 m³ to 135,000 m³ (˜475,000 to 850,000 bbl) of water is required to develop one well drilled 2,400 m (7,875 ft) deep, in a typical unconventional shale oil and gas development. A typical mid-size to large shale production facility may be supplied by tens to thousands of wells at varying stages of the production lifecycle. Depending on the subsurface characteristics, less than 50% to greater than (in case of connate water return) or up to 100% of the water used for the initial hydraulic fracturing operation is returned to the surface. Additional water usage may be incurred for workovers and intervention on producing wells.

Thus, water usage is a big concern to the industry, especially in areas where water tables are depleting fast or where produced water disposal is constrained due to geological, environmental, or other reasons. Re-use of produced water is thus typically recommended to reduce the volume of fresh water needed and to minimize fluid sent to disposal.

However, produced water is highly contaminated, containing dissolved gases, oil, organic acids, dissolved inorganic solids, such as salts of sodium, calcium, magnesium, iron, manganese, strontium, and naturally occurring radioactive materials (NORM). Thus, to re-use produced water, treatment is necessary to produce a water stream that is compatible with chemicals used in hydraulic fracturing, the subsurface geochemistry, and that can be stored in a stable state between production to surface and reuse.

Iron is of particular concern in this disclosure. Produced water may contain up to 20-60 mg/L or more of dissolved iron, primarily due to dissolution of iron containing minerals from geological matrix during rock-water interaction, and/or due to corrosion of steel casing materials. Soluble ferrous iron tends to form solid precipitants when exposed to oxygen, with the reaction rate and extent being dictated primarily by pH, occurring at near neutral to basic conditions. The reaction products of oxidation are typically iron (III) oxide/ferric oxide (Fe₂O₃) or iron (III) hydroxide/ferric hydroxide (Fe(OH)₃), as shown in EQ a and b of FIG. 1.

Iron-based deposits cause fouling of produced water storage ponds and ancillary equipment. Microbial growth can also occur, because the iron allows certain types of microbes to thrive. Biocides may not readily achieve microbial deactivation where microbes are shielded by solids, such as precipitated iron or other organic or inorganic sludge, leading to potential asset integrity issues, souring of the stored produced water, and impacting the ability to readily reuse the water. Solids formed when iron oxides deposit may also impact well performance if they are pumped into a well during initial hydraulic fracturing or during well interventions and workovers. Furthermore, if naturally occurring radioactive material (NORM) contamination is present in produced water, it may coprecipitate with iron oxide solids, producing waste material with challenging handling and disposal requirements.

Dissolved iron is typically removed in a produced water treatment facility by conventional water treatment technologies, such as pH adjustment, oxidation, coagulation, and flocculation, followed by clarification or dissolved air, gas or nitrogen flotation (DAF, DGF, DNF) and/or filtration to remove suspended precipitated iron and other solids. Chemicals like hydrogen peroxide have been traditionally used for removal of dissolved iron in a produced water treatment facility. The oxidation of dissolved iron converts Fe²⁺ to insoluble Fe³⁺. Typically, gas flotation technologies are used for removal of bulk suspended solids, following coagulation and flocculation, prior to deep bed media filters used to remove residual suspended solids. In the presence of chelated iron, however, oxidative chemistry (such as peroxide, bleach, etc.) is not very effective.

We now know that certain polymers can chelate iron, contributing to the difficulty in removing iron. For example, during hydraulic fracturing to develop unconventional wells in shale plays, fracturing fluids are injected into the reservoir and contain chemical additives, such as acids, biocides, gelling agents, friction reducers (FR), emulsion breakers, and the like. See FIG. 2.

Friction reducer chemicals are employed in most unconventional hydraulic fracturing operations. Friction reducer chemistry may be classified as anionic, cationic or nonionic and include long chain polyacrylamides (PAM) or polyacrylic acid compounds (PAA). Friction reducers may also contain monomers of acrylamido-methylpropane sulfonate polymer (AMPS), and/or partially hydrolyzed polyacrylamide (PHPA) among other polymers (shown in FIG. 3). These friction reducers are typically long chain polymers that act to diminish turbulent eddies formed when fluid is pumped at high rates, in turn reducing frictional hydraulic losses and allowing higher fluid pump rates to be used for hydraulic fracturing. The increased pumping rates allow for higher proppant loading, as the higher fluid velocity is better able to keep sand particles suspended in the hydraulic fracturing fluid. Higher pump rates may also reduce hydraulic fracturing duration.

Iron in the produced water or from formation rocks can react with the functionality present in friction reducers and/or breakers and other polymers and may chelate or flocculate the polymer or reduce the viscosity build that is desired for efficient friction reducer performance. FIG. 4 shows a typical iron-PAA chelate structure.

While methods exist to remove dissolved and particulate iron from produced water, they are typically ineffective in treating produced waters having polymer chelated iron therein. Thus, what is needed in the art are better methods to treat produced waters having polymer chelated iron due to residual friction reducer and other polymers. The ideal method would be cost effective, eliminate, reduce, or reverse the possibility of iron complex formation, be compatible with scale inhibitors and other flow assurance chemicals, prevent produced water storage pond fouling and microbial contamination and be both reliable. This invention addresses one or more of these needs.

### SUMMARY OF THE DISCLOSURE

ConocoPhillips Canada owns and operates a produced water treatment plant (“the Plant”) where mixed sweet and sour gas, free liquid condensate and produced water from a North American shale play are processed. Produced water is treated for reuse in hydraulic fracturing and oilfield operations, targeting oil removal, microbial deactivation, removal of trace hydrogen sulfide, iron sulfide and iron by neutral pH chemical oxidation, and removal of suspended solids (including elemental sulfur and iron oxides/hydroxides formed through chemical oxidation) using dissolved nitrogen flotation and media filtration. The treated produced water is stored in lined storage lagoons, equipped with submersible transfer pumps to deliver treated produced water to future well sites for hydraulic fracturing or other applications.

Initial Plant operation processed fluids from existing wells and new flowback production from a 14 well pad. All wells initially producing to the facility were hydraulically fractured using fresh surface water and consisted of either slickwater or high viscosity loadings of anionic polyacrylamide. During this initial operating period, the produced water treatment facility was able to reliably produce effluent with typically less than five mg/L dissolved iron and low turbidity (<10 NTU).

Through the treatment process of these initial wells, iron was readily oxidized using hydrogen peroxide dosing at neutral to slightly basic pH. Following chemical oxidation, the aqueous pH was observed to lower by approximately half to one unit, as expected when Fe²⁺ (ferrous iron) is oxidized to Fe³⁺ in the form of ferric hydroxide (Fe(OH)₃), removing soluble hydroxide from the aqueous solution. The iron oxide/hydroxide was readily flocculated using a low charge density, high MW anionic polyacrylamide flocculant, forming a dense stable floc that was readily removed by gas flotation. The trace oil and solids were removed by downstream filtration.

The initial treated produced water generated at the Plant was then reused for hydraulic fracturing of a second large multiwell pad. The anionic polyacrylamide used for hydraulic fracturing of the earlier wellpad was found to flocculate when blended with the high salinity cleaned produced water, and any polymer remaining in solution was unable to achieve meaningful reduction in friction losses or viscosity build when tested in the laboratory. Thus, to enable reuse of the cleaned produced water in hydraulic fracturing, a change to the friction reducer chemistry was necessary.

Extensive laboratory testing was performed to find a polymer friction reducer that was able to build viscosity and achieve friction reduction in treated produced water. The selected product was a copolymer consisting of 2-acrylamido-2-methylpropane sulfonic acid (AMPS) co-polymerized with an unknown proprietary monomer. The wells were hydraulically fractured in several stages, making use of fresh surface water, anionic polyacrylamide friction reducer, sodium perborate breaker, biocide (glutaraldehyde/quaternary ammonia) and sand proppant. Between fresh water stages, treated produced water was utilized with a fluid package consisting of AMPS co-polymer, biocide and sand.

During flowback of this second multiwell pad, a shift in produced water treatability was observed at the Plant. The dissolved iron was measured using the phenanthroline method (see 3500-Fe B ‘Phenanthroline method or designation’ or ASTM E 394-00 ‘Iron in trace quantities using the 1,10-Phenanthroline method’, both incorporated by reference in its entirety for all purposes), and the amounts were validated by inductivity coupled plasma optical emission spectroscopy (ICP OES). Using these methods, iron was found to gradually increase over the course of 2 months until there was no change in total or dissolved iron concentration through the Plant.

During this time, strong oxidizing conditions were present (>25 mg/L hydrogen peroxide from plant discharge) and the fluid pH was neutral to basic. Following hydrogen peroxide dosing, the pH reduction observed previously when treating produced water due to iron hydroxide formation was no longer observed. The color of water changed following chemical oxidation to an orange hue, however the compound(s) responsible for this color change were found to pass readily through a 0.45-micron membrane filter, along with the measurable dissolved iron, indicating that iron remained in solution in the form of a complex.

The root cause of the chelation was found to be interaction between the residual AMPS copolymer and the dissolved iron. Due to the strong chelation of iron by the residual friction reducer polymer, it could not be removed by chemical oxidation using hydrogen peroxide at neutral pH, and remained in soluble form, passing through 0.45-micron filtration during the timescale of residence in the produced water treatment plant (<24 hrs).

However, after storage in produced water ponds spanning several months of hold time, the iron was found to gradually be partially liberated from the chelant bond, with iron oxide/hydroxide solids precipitating and fouling the storage ponds. The resulting solids were found to be concentrated with NORMs solids, which would otherwise have been coprecipitated with ferric oxide/hydroxide solids and removed with the iron oxide/hydroxide solids slurry in the water treatment process.

This disclosure provides means for treating produced water having polymer-iron chelates by treating with a low basicity aluminum coagulant at ambient conditions, followed by pH neutralization, oxidation, flocculation and solids removal. While the mechanism is uncertain, we believe that low basicity aluminum coagulates polymer remnants, either coprecipitating polymer and iron, or reacting with anionic functional groups on the polymer, in either case freeing chelated iron. Once the iron is freed from the chelate, the iron can be treated using any known or to be developed method of water treatment to produce cleaned water.

In another embodiment, we decompose high molecular weight polymers in produced water by treating the “not yet-produced water” while still in the reservoir with oxidants at a first temperature of at least 55° C. or at least 70° C., waiting a period of 5-30 days at the first temperature until polymer remnant can no longer chelate iron, and then producing the water (and oil). Then, the produced water is treated at surface conditions using neutral pH oxidation for iron precipitation, followed by coagulation, flocculation and settling, flotation and/or filtration of precipitated solids or any other means known or to be developed in the art for removing iron.

If needed, the various fluids are tested using high performance liquid chromatography (HPLC) size exclusion chromatography (SE) to confirm that at least 80%-85% of the polymer-chelate has degraded, or at least 90%-95%. If polymer chelate continues to be an issue, more oxidant or breaker can be added at the surface or injected downhole, reaction time can be increased, temperature can be increased (where possible), or a combination thereof may be employed. Once reaction conditions for treating produced water with polymer-iron chelate from a given reservoir have been optimized, this testing may be omitted unless conditions change, e.g., by changing hydraulic fracturing fluids.

As used herein, “hydraulic fracture” is a fracture created through injection of pressurized fluids called “fracturing fluids.” There are also natural fractures in the reservoir, that exist even before hydraulic fracturing.

As used herein, “flowback” is the initial flow of water after bringing a well online. Flowback includes both completion fluid and formation water, but will be similar in composition to the completion fluid. Flowback may also contain chemical additives, dissolved metals, and salts.

“Produced water” or “PW” is water that comes out of the well with crude oil during crude oil production and is then separated from the oil. PW can contain water naturally present in the rock, water injected into the reservoir in enhanced oil recovery (EOR) or steam-based operations, and water from hydraulic fracturing operations. It also includes some soluble and insoluble hydrocarbon and organics, dissolved inorganic salts and various chemicals used in production and hydraulic fracturing process. Both flowback and PW are essentially referred to as “produced water” or PW herein.

As used herein, a friction reducer or “FR” is a long chain polymer used to reduce friction and allow faster pumping of fracturing fluids. When added to the hydraulic fracturing fluid, the hydraulic fracturing fluid may be called “slickwater.”

As used herein, when we refer to treating PW “at surface conditions,” we mean surface temperatures, which range widely depending on geographic locale, and about 1 atm, depending on elevation. This would typically cover a range of 0 to 50° C. By contrast, “downhole conditions” may be at much higher temperatures and pressures.

As used herein, “stabilized H₂O₂” is a grade of H₂O₂ that contains chelants and sequestrants to minimize its decomposition under normal storage and handling conditions. Common stabilizers include: colloidal stannate and sodium pyrophosphate (present at 25-250 mg/L); organophosphonates (e.g., Monsanto's Dequest products); nitrate (for pH adjustment and corrosion inhibition) and phosphoric acid (for pH adjustment); and colloidal silicate is used to sequester metals and thereby minimize H₂O₂ decomposition in certain applications that depend on the bleaching ability of H₂O₂ in alkali.

As used herein, an aluminum compounds, includes any aluminum containing molecule that functions to free iron from the chelates. Herein we use aluminum polyelectrolytes, aluminum salts, including aluminum sulfate, and polyaluminum coagulants, including polyaluminum chloride (PAC) or aluminum chlorohydrate.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The invention includes any one or more of the following embodiments in any combination(s) thereof
A method of cleaning produced water, comprising: a) treating a produced water having iron-polymer chelates with either an aluminum compound at surface conditions to free iron or an oxidant at a temperature of at least 55° C. to free iron; and b) oxidizing said free iron by neutral pH oxidation; and c) removal of said oxidized iron to produce cleaned produced water.
A method of cleaning produced water from a reservoir, said method comprising: a) testing a water produced from a hydrocarbon reservoir (“produced water”) to confirm that iron is chelated by a high molecular weight (“MW”) polymer in said produced water, and if so treating said produced water having polymer chelated iron at a temperature of 55° C. or greater with an amount of an oxidant for a period of time sufficient to convert said polymer to polymer remnants that no longer chelate iron and producing free iron; b) oxidizing said free iron by neutral pH oxidation; and c) removing said polymer remnants and said iron to produce cleaned produced water.
A method of cleaning produced water from a reservoir, said method comprising: a) testing a water produced from a hydrocarbon reservoir (“produced water”) to confirm that iron is chelated by a high molecular weight (“MW”) polymer in said produced water, and if so performing steps b and c; b) treating said produced water having polymer chelated iron at a temperature of 55° C. or greater with an amount of an oxidant for a period of time sufficient to convert said polymer to polymer remnants that no longer chelate iron; and c) removing said polymer remnants and said iron to produce cleaned produced water.
A method of hydraulic fracturing, comprising: a) testing a polymer suitable for use in hydraulic fracturing to determine said polymer will chelate iron; b) testing an oxidant for said polymer to determine if it will degrade said polymer at reservoir temperatures to form polymer fragments that will not chelate iron; c) fracturing a reservoir with a hydraulic fracturing fluid comprising water, said polymer and said oxidant; d) waiting a period of time to degrade said polymer to polymer fragments that no longer chelate iron; e) producing oil and water from said reservoir and separating said produced oil from produced water; f) optionally testing said produced water to confirm that iron is free iron, and if a portion of said iron remains chelated, adding more oxidant to further degrade said polymer; g) treating said produced water to oxidize free iron by neutral pH oxidation; and h) removal of said oxidized free iron.
A method of hydraulic fracturing, comprising: a) fracturing a reservoir with a hydraulic fracturing fluid comprising water and a polymer that can form polymer-iron chelates; b) producing oil and water from said reservoir and separating said produced oil from produced water; c) treating said produced water having polymer-iron chelates with an aluminum compound to form free iron; d) treating said produced water to oxidize free iron by neutral pH oxidation; and e) removal of said oxidized free iron.

Any method herein described, wherein said oxidant is selected from the group consisting of H₂O₂, sodium persulfate, ammonium persulfate, sodium perborate, or combinations thereof.

Any method herein described, wherein said oxidant is sodium- or ammonium-persulfate.

Any method herein described, wherein step b is performed downhole.

Any method herein described, wherein step b is performed at the surface.

Any method herein described, wherein said high molecular polymer is selected from the group consisting of acrylamido-methylpropane sulfonate polymer (AMPS), polyacrylamide (PAM), polyacrylic acid (PAA) and partially hydrolyzed polyacrylamide (PHPA), or copolymers thereof.

Any method herein described, wherein said high MW polymer is AMPS or copolymers thereof.

Any method herein described, further comprising step b2, repeating said testing step a) to confirm that at least 80% of said high MW polymer is converted to polymer remnants before proceeding to step c, and if less than 80% is converted, then increasing said period of time, said temperature, said amount, or combinations thereof.

Any method herein described, wherein said oxidant is sodium- or ammonium-persulfate, said polymer is AMPS, and said temperature is at least 70° C.

Any method herein described, wherein said removal step c) methodology is selected from one or more of precipitation, flotation, centrifugation, decantation, filtration and combinations thereof.

Any method herein described, wherein said aluminum compound is selected from the group consisting of polyaluminum chloride, aluminum chlorohydrate, and polyaluminum sulfate.

Any method herein described, wherein said aluminum compound is polyaluminum chloride, and the pH is maintained at pH 7.0+/−0.25.

Any method herein described, further comprising a pre-testing step i) to confirm that said produced water has iron-polymer chelates.

Any method herein described, further comprising a post-testing step b2) to confirm that said at least 80% of iron is free iron.

Any method herein described, further comprising re-using any water herein cleaned of polymer-iron chelates downhole.

Any method herein described, further comprising re-using any water herein cleaned of polymer-iron chelates downhole for hydraulic fracturing.

Any method herein described, further comprising re-using any water herein cleaned of polymer-iron chelates and blended with fresh water downhole for hydraulic fracturing.

Any method herein, wherein treatment with said aluminum compound is at surface conditions.

Any method herein described, wherein treatment with said aluminum compound is at reservoir conditions. Preferably, at least 55° C. or at least 70° C.

Any method herein described, wherein a polymer for proposed used downhole is first tested for its ability to chelate iron.

Any method herein described, wherein an oxidant or aluminum compound for proposed use to free iron is first tested for its ability to free iron.

Any method herein described, wherein an oxidant or aluminum compound for proposed use to free iron is first optimized for its ability to free iron, such that an ideal temperature, length of time and/or concentration may be employed.

Any method herein described can be performed at the surface or downhole, or combinations thereof, recognizing that the so-called “produced water” has not yet been produced in a downhole treatment.

Any method herein described, wherein interim testing is performed to confirm that at least 80%, 85%, 90%, 95%, 96%, 97%, 98%, 99% or all of the polymer degrades before proceeding with iron removal. If not, oxidant or aluminum salt, temperature, time, or combinations thereof, are increased. In the alternative, testing may be performed in advance to establish conditions under which polymer degradation will proceed to completion.

Any method herein described, wherein said high molecular weight friction reducers or polymers are selected from the group consisting of acrylamido-methylpropane sulfonate polymer (AMPS), polyacrylamide (PAM), polyacrylic acid (PAA) and partially hydrolyzed polyacrylamide (PHPA), or copolymers thereof.

Any method herein described, wherein said oxidant is selected from the group consisting of H₂O₂, sodium persulfate, ammonium persulfate, sodium perborate, oxidants employed as breakers for friction reducers, or combinations thereof. Preferably, about 0.0038 kg/m³-0.1 kg/m³ of ammonium persulfate are used, although amounts may vary based on the amount of polymer used.

Any method herein described, wherein said treatment of “produced water” is at reservoir temperature, preferably at least about 40° C., 50° C., 60° C. or 70° C.

Any method herein described, wherein said base is sodium hydroxide.

Any method herein described, wherein said aluminum compound or coagulant is selected from the group consisting of polyaluminum chloride, aluminum chlorohydrate and polyaluminum sulfate. Preferably, the aluminum compound is polyaluminum chloride, and the pH is maintained at pH 7.0+/−2.

Any method herein described, wherein said removal step methodology is selected from one or more of precipitation, flotation, centrifugation, decantation, filtration and combinations thereof.

Any method herein described, further comprising mixing said cleaned produced water with fresh water for re-use in mixing fracturing fluids for use downhole.

Any method herein described, wherein the polymer degradation is performed at least 50° C. or at least 70° C. for a period of time. Ideally, the period of time is bench top tested in advance of field use, but it can also be tested by sampling the reservoir at suitable intervals. This testing is used to confirm that at least 80%, 85%, 90%, 95%, 96%, 97%, 98%, 99% or all of the polymer degrades before proceeding with oil production.

The following abbreviations are used herein:

| ABBREVIATION | TERM |
|---|---|
| AMPS | Acrylamido-methylpropane-sulfonate |
| CPF | Central processing facility |
| DAF | Dissolved air flotation |
| DNF | Dissolved nitrogen flotation |
| DGF | Dissolved gas flotation |
| EOR | Enhanced oil recovery |
| FR | Friction reducer |
| HPLC | High performance liquid chromatography |
| SEC-HPLC or | Size exclusion high performance liquid |
| HPLC-SE | chromatography |
| HVFR | High viscosity friction reducer |
| ICP | Inductively coupled plasma |
| MW | Molecular weight |
| NORM | Naturally occurring radioactive mmaterial |
| OES | Optical emission spectroscopy |
| PAA | Polyacrylic acid |
| PAC | Polyaluminum chloride |
| PAM | Polyacrylamide |
| PHPA | Partially hydrolyzed polyacrylamide |
| Ppmv | Parts per million volume |
| ppt | Parts per trillion |
| PW | Produced water |
| SE | Size exclusion |
| PWRI | Produced water re-injection |
| SI | Scale inhibitor |
| XRD | X-Ray diffraction |

### BRIEF DESCRIPTION OF THE DRAWINGS

FIG. 1 Reaction of iron to form ferric oxide and ferric hydroxide.

FIG. 2. Hydraulic fracturing fluids.

FIG. 3. Some HVFR polymers.

FIG. 4. Iron-PAA chelate structure.

FIG. 5. Iron floc suspended in produced water.

FIG. 6. Plot of total iron concentration versus time showing degradation in iron treatability associated with flowback of wells fractured with AMPS copolymer and treated produced water.

FIG. 7. Plot of pH versus time compared with plot of residual H₂O₂ versus time.

FIG. 8. HPLC trace of produced water from various wells indicating the presence of high MW polymers.

FIG. 9A. Bottle test result for “A” well after treatment for iron.

FIG. 9B. Bottle test result for “B” well after treatment for iron.

FIG. 10A. Bottle test result for produced water (sample “C”) at varying pH after addition of aluminum sulfate for coagulation.

FIG. 10B HPLC trace indicating high MW polymer presence.

FIG. 10C Aluminum dosage v. cation concentration.

FIG. 11A-B. HPLC trace for thermal testing of produced water with AMPS co-polymer with no added breaker (sample “C”).

FIG. 12A. Bottle test result for produced water with 1 L/m³ AMPS co-polymer, and FIG. 12B with 3 L/m³ AMPS co-polymer without added breaker.

FIG. 13A-B. HPLC trace for thermal testing of produced water with AMPS co-polymer with 3.8 g/m³ of sodium perborate breaker.

FIG. 14A. Bottle test result for produced water with 1 L/m³ AMPS co-polymer and FIG. 14B with 3 L/m³ AMPS co-polymer with sodium perborate breaker.

FIG. 15A-B. HPLC trace for thermal testing of produced water with AMPS co-polymer with 3.8 g/m³ of ammonium persulfate breaker.

FIG. 16A. Bottle test result for produced water with 1 L/m³ AMPS co-polymer and FIG. 16B with 3 L/m³ AMPS co-polymer with ammonium persulfate breaker.

FIG. 17A-B. HPLC trace for thermal testing of produced water with AMPS co-polymer with 0.76 g/m³ of H₂O₂ breaker.

FIG. 18A. Bottle test result for produced water with 1 L/m³ AMPS co-polymer and FIG. 18B with 3 L/m³ AMPS co-polymer with H₂O₂ breaker.

FIG. 19. A typical benchtop mini flowloop set-up.

FIG. 20. Mini flowloop test result.

FIG. 21. Flowloop test result—temperature ramp.

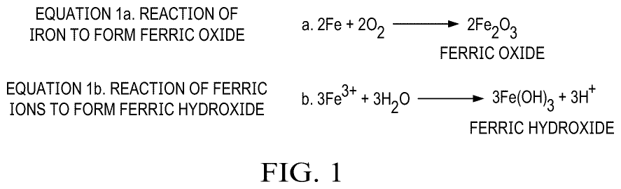

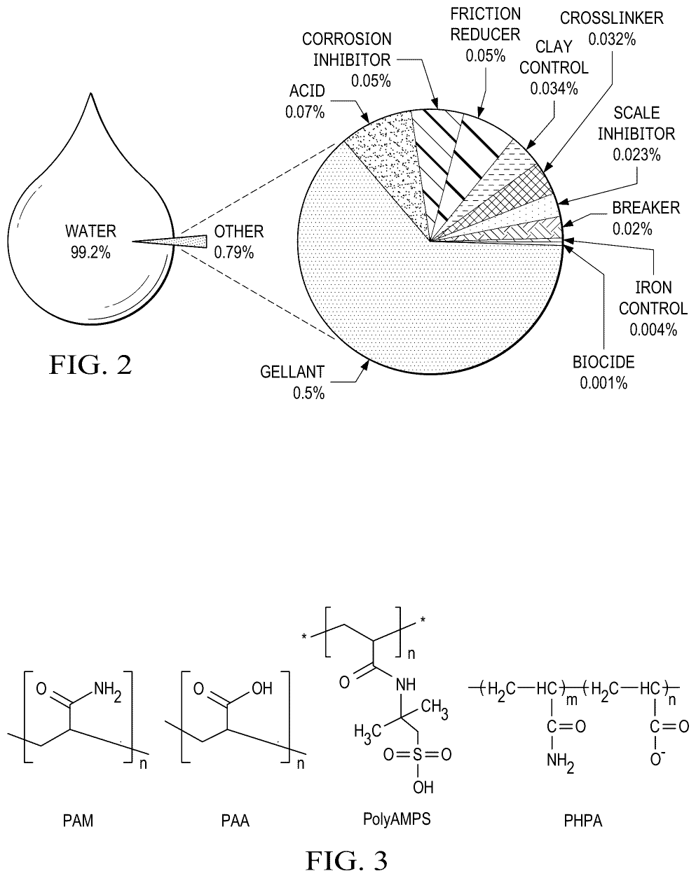

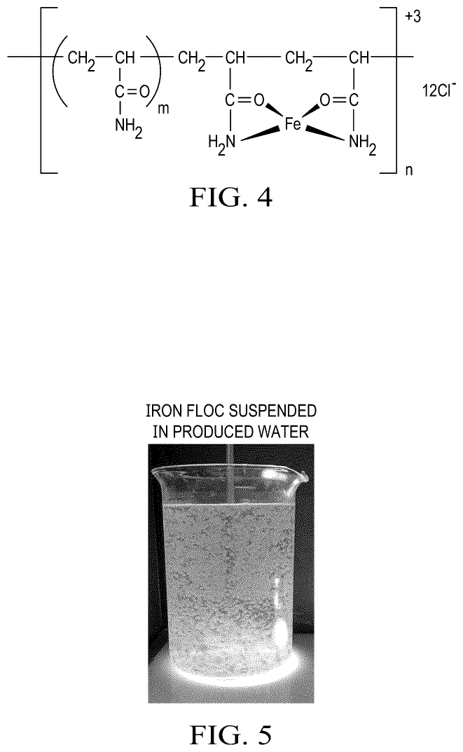

### DETAILED DESCRIPTION

The presence of high MW polymer in the produced water from a North American unconventional play was measured by high performance liquid chromatography (HPLC) size exclusion (SE) chromatography. Wells hydraulically fractured using typical anionic polyacrylamide friction reducers and fresh water did not show evidence of high MW polymer presence in produced water. However, wells hydraulically fractured using produced water or mixed fresh and produced water with ‘salt tolerant’ AMPS copolymer were found to contain elevated concentrations of high MW polymer residue, even several years after initial flowback. Iron in the produced water is readily chelated by residual AMPS, making removal of iron from the produced water challenging and in turn causing produced water storage and re-use difficult.

To understand iron-chelate problem in produced water, it was first necessary to ascertain that iron was indeed chelating with polymers from the produced water. All experiments were conducted at benchtop for proof of concept.

Produced water samples from wells at an unconventional play were treated in the lab using pH adjustment (sodium hydroxide pH neutralization) and chemical oxidation using hydrogen peroxide (H₂O₂), and then filtered with a 0.45-micron Millipore filter. The filtrate liquid was visually observed for particles and iron and dissolved iron was measured using inductively coupled plasma (ICP) optical emissions spectroscopy (OES).

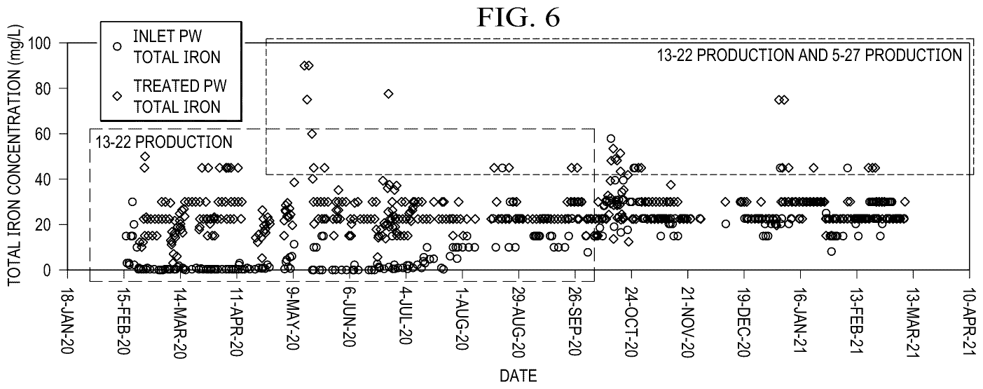

FIG. 6 shows a plot of total iron concentration in produced water versus time for produced water entering a central processing facility. During the initial time-period, the central processing facility was treating produced water from wells that were hydraulically fractured using an anionic polyacrylamide friction reducer, sodium perborate breaker and fresh surface water. During this time, it was observed that the produced water was readily treatable for iron removal by neutral pH chemical oxidation, as seen from the iron concentration levels of <5 mg/L for treated produced water between January and July 2020.

In August 2020, however, flowback commenced from a new wellpad, for which a mix of fresh and treated produced water had been utilized for hydraulic fracturing. The stages fractured using treated produced water made use of 2-acrylamido-2-methylpropane sulfonic acid (AMPS) copolymer friction reducer at up to 3 L/m³ loading, with no oxidant breaker employed. Following flowback of this second multiwell pad, the total iron concentration in the treated produced water began to increase as shown in the plot between August 2020 to March 2021. The iron concentration for this period can be seen at about 20 mg/L, stabilizing to be equal to the influent iron concentration.

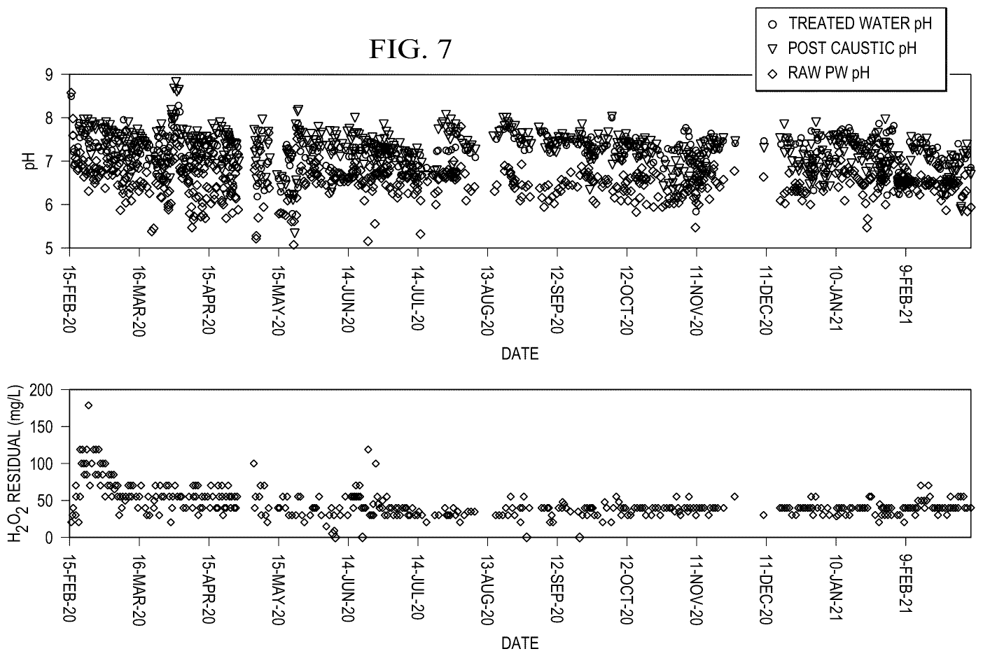

The pH trace of the produced water after chemical oxidation using H₂O₂ is shown in FIG. 7 and compared with residual H₂O₂ in solution after oxidation. After the addition of H₂O₂, the pH of the solution should reduce as Fe(OH)₃ precipitates. Data between February till August 2020 showed this reduction of pH trend, but once the influent produced water contained flowback water from the wells fractured with AMPS copolymer friction reducer, the pH of solution remained basic, indicating that the H₂O₂ was not being consumed for oxidation, as would be expected by the ˜50 mg/L residual H₂O₂ in solution.

Produced water from wells that were hydraulically fractured using AMPS co-polymer without the use of an oxidant breaker were found to contain a high concentration of dissolved iron (>10 mg/L) post treatment. The clarity of the supernatant water was poor. The iron particles passed through the 0.45-micron filter, thus no visible iron oxide/hydroxide floc was formed.

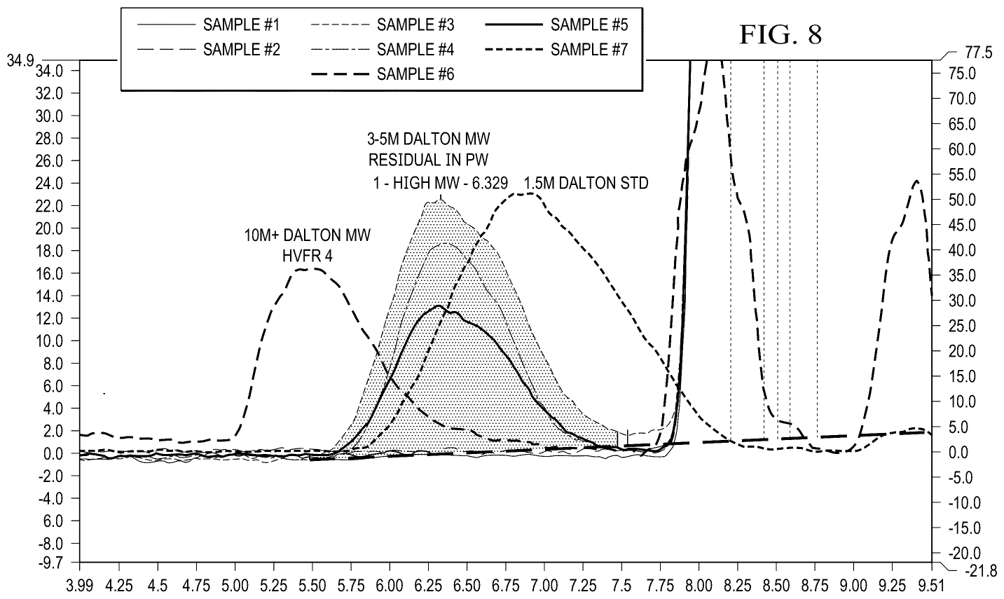

Next the raw produced water that was used to formulate the water samples described above were analyzed using SE-HPLC. The analysis indicated distinct differences between the samples that were ‘treatable’ for iron removal and those that were not, as shown in FIG. 8. The treatable samples contained a clear chromatogram response at 8 to 10 minutes column residence time that could be attributed to typical inorganic cations and anions in solution, with no peaks at lower residence time that could be attributed to higher MW organic compounds.

In contrast, analysis of the samples that could not be readily treated for iron removal using chemical oxidation showed a HPLC detector response peak at around 6 to 7 minutes residence time, attributed to presence of high molecular weight (MW) polymers in the order of about 3 to 5 million Daltons. Based on the propensity for AMPS to bind with iron and the stability of the salt tolerant friction reducers, the root cause of iron removal issues is directly related to excess friction reducer polymer fragments present in the produced water.

Efficiency of oxidant breakers in downhole degradation of AMPS co-polymer was also evaluated at reservoir temperature (70° C. in this case). Control experiment with no breaker in produced water was tested along with addition of oxidant breakers like persulfate, perborate, stabilized H₂O₂, etc. that were dosed in at 1.9-11.4 g/m³ of total solution volume.

To study the fate of iron in the hydraulic fracturing fluid-friction reducer matrix, ferric chloride was dosed to each sample solution (60 mg/L Fe equivalent) after a hold time of 5 days at 70° C. Weekly analysis indicated substantial change to polymer residue MW after the samples were spiked with ferric chloride. The polymer breakdown was rapid compared to samples that were only treated with breakers and not spiked with ferric chloride. Visual observation also showed that the samples spiked with ferric chloride had varying degrees of polymer flocculation. The addition of ferric chloride as a sudden rapid dose may have artificially accelerated polymer degradation beyond what would be observed in the reservoir naturally. Therefore, in future work it was added more slowly.

Following four weeks of hold time at 70° C., with three of those weeks after dosing of ferric chloride, the fluid in each jar was treated for iron removal by adjusting the pH to neutral and adding hydrogen peroxide at 100 mg/L. The supernatant water was filtered through a 0.45-micron membrane filtration, before analysis by ICP OES for dissolved iron concentration. The results show that ammonium persulfate breaker was the most effective for iron removal by neutral pH chemical oxidation, with <5 mg/L residual iron present after treatment even with up to 3 L/m³ AMPS copolymer initial fluid loading.

A novel combination of static breaker testing, and rock-water interaction testing was also conducted to test the action of oxidant breakers on AMPS co-polymer under downhole degradation conditions. The purpose of adopting this combination tests was to simulate dissolution of iron and other ions from rock (in place of ferric chloride dosing), intended to better balance the kinetics of polymer degradation by oxidation and cation/anion dissolution. The combination testing was conducted to optimize oxidant breaker dosage for varying AMPS co-polymer loadings and to provide a customized chemical package to minimize chemical cost and ensuring AMPS co-polymer degradation to avoid iron chelation in produced water.

The basic testing procedure was:
a. An oxidant breaker was added to the hydraulic fracturing fluid at ambient surface conditions.
b. Samples were removed at regular intervals to analyze the inorganic composition by ICP OES and the polymer molecular weight distribution by SEC-HPLC.
c. At the conclusion of the experiment, once the rate of polymer MW changes had significantly slowed, the supernatant fluid was separated from solids, and treated by pH neutralization with sodium hydroxide, followed by oxidation using hydrogen peroxide.
d. The iron floc was removed by mechanical methods, leaving clear produced water, with low dissolved iron (<5 mg/L).
e. In some variations to this method, additives such as sand, rock (drill cuttings), hydrochloric acid for pH adjustment, chemical oxygen scavenger or nitrogen for oxygen stripping were added to mimic downhole conditions and mitigate oxidation of ferrous iron in the aqueous solution.

When treating produced water at surface conditions (e.g., room temperature) containing iron and residual AMPS copolymer, addition of oxidants such as hydrogen peroxide and Fenton's reagent, was found to be ineffective, and a significant amount of soluble/complexed iron was left in solution.

However, for surface ambient condition applications, aluminum compounds, such as aluminum polyelectrolytes, aluminum salts, including aluminum sulfate, and polyaluminum coagulants, including polyaluminum chloride (PAC) or aluminum chlorohydrate, were found to be effective in removing iron or at least making iron accessible for removal by oxidation at neutral pH. The decomposed polymer and iron floc were removed by one or more industrially accepted mechanical treatment methods, such as precipitation, centrifugation, filtration, decantation, flotation, sedimentation or combinations thereof. Thus, this treatment led to effective removal of polymer residue and iron in the form of iron floc from produced water.

For tests to degrade high MW AMPS copolymers into smaller fragments to prevent iron chelation in produced water at formation temperatures, the tests were conducted at 70° C. Oxidants tested for their ability to degrade AMPs copolymer at reservoir conditions included sodium perborate, stabilized hydrogen peroxide, ammonium persulfate and sodium persulfate. Breakers may also include sodium perborate tetrahydrate and solubility increasing boron complex or ester forming compounds; enzymatic breakers such as hydrolases (if the enzymes are sufficiently stable in PW); inorganic peroxide particles, such as calcium peroxide or magnesium peroxide, and the like.

Under the reservoir testing conditions, sodium or ammonium persulfate were found to be effective for reducing residual polymer MW, and thus preventing or reversing iron chelation with polymers. These oxidants were found to be effective for polymer decomposition at temperatures of 55 to about 75° C. or higher. Effectiveness was found to be dependent on the presence of dissolved iron.

The above experiments are discussed in more detail in the following examples:

### 1: Produced Water Treatment at Surface Conditions

Produced water treatment for removal of dissolved iron on benchtop is carried out as described below:
a. To a 100 mL solution of produced water, 50% NaOH solution was added to achieve a target pH of 7-7.5.
b. H₂O₂ addition was carried out with a solution of 3 wt. % H₂O₂ to achieve residual H₂O₂ of 25 mg/L in solution.
c. After 5 minutes reaction time, the solution was filtered to achieve clear supernatant liquid. HPLC trace of the supernatant liquid was carried out to determine the residual polymer MW, with ICP OES used to measure for residual dissolved/chelated iron.

Samples where high MW polymer was detected were difficult to treat for iron removal by oxidation, indicating that the polymers had to be broken down into smaller fragments to successfully remove iron from the solution. The presence of iron that can be passed through a 0.45-micron pore size filter despite the fluid conditions being near neutral pH with an excess of hydrogen peroxide oxidant present indicates that the iron is chelated.

In general, commercially available sodium perborate tetrahydrate, sodium persulfate, ammonium persulfate or stabilized hydrogen peroxide or any other polymer breaker may be used for downhole polymer degradation. A commercially available AMPS copolymer was used for all experiments described herein.

Table 1 shows the result of produced water treatability and iron removal of two samples, referred to from this point on as “A” well and “B” well, after treatment with pH neutralization and addition of oxidant H₂O₂. HPLC was used to determine the presence of high molecular weight polymers in the samples after oxidant treatment. With the presence of high MW polymer in the sample (“B” well), removal of iron from solution was poorer (12.566 mg/L residual Fe) compared to the sample that contained low MW polymers (“A” well), which showed significant removal of iron (0.007 mg/L residual Fe).

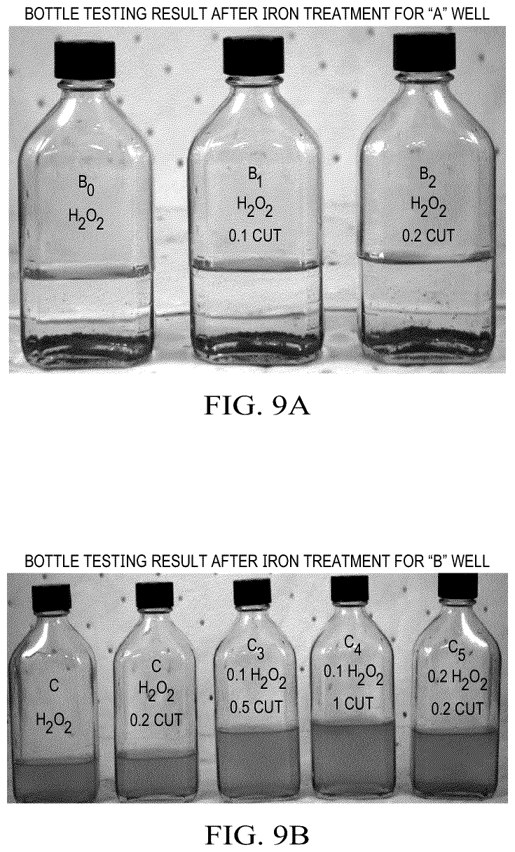

FIG. 9A shows the bottle test with a clear supernatant and precipitated iron floc for “A” well PW test, FIG. 9B shows the bottle test result with hazy supernatant for the “B” well.

TABLE 1
Residual Fe after treatment with oxidant H₂O₂

| | High MW | H₂O₂ | Residual | |
|---|---|---|---|---|
| | polymer | Dosage | dissolved Fe | Clear |
| Well | present | (mg/L) | (mg/L) | Supernatant |
| “A” | No | 100 | 0.007 | Yes |
| “B” | Yes | 100 | 12.566 | No |

To test alternative methods for removal of iron chelated by high MW polymer, Fenton's reagent catalyst was added with oxidant. The catalyst, containing complexed iron, is used to catalyze hydrogen peroxide degradation and free radical formation. The free radical hydroxide and hydroperoxyl formed by catalytical degradation of hydrogen peroxide are powerful oxidants, having a significantly higher oxidation potential than hydrogen peroxide alone. This was found to be ineffective for pH ranging from 3-8 and improved slightly in performance at pH 8, but higher pH can cause calcite scale and thus, this application is not preferred. Addition of ferric chloride coupled with H₂O₂ was also found to be ineffective for polymer degradation at all ranges of pH. Oxidation of the residual high MW polymer for the purpose of enabling removal of iron by oxidation and precipitation at surface conditions was found to be ineffective at surface ambient conditions.

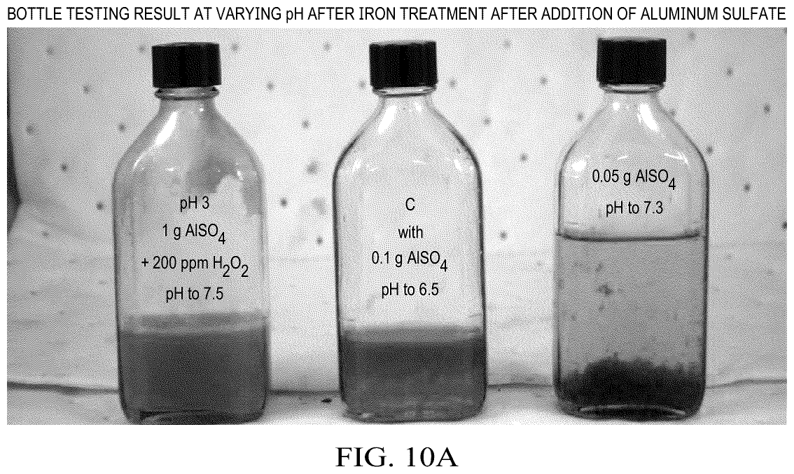

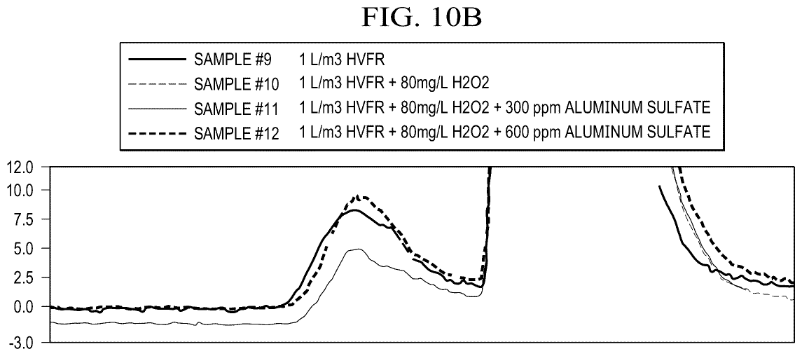

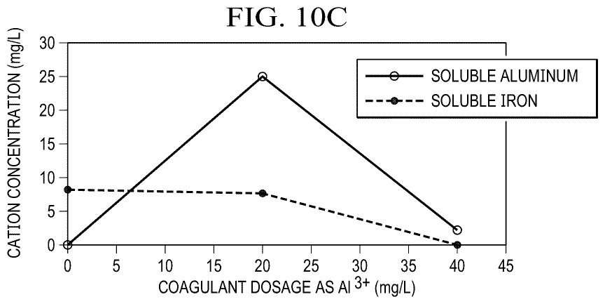

In bench testing, aluminum sulfate dosing to AMPS copolymer contaminated iron rich produced water was also tried (FIG. 10A) and found effective for removal of dissolved/chelated iron at high dosages. However, extremely high doses of aluminum sulfate were required, rendering it less practical due in part to the excessively high solids generation and depression of the aqueous pH. At pH of 7.3, significant precipitation of solids was observed, and the supernatant was not clear even after prolonged sedimentation.

Additional testing using aluminum polyelectrolytes in place of aluminum sulfate was performed. Aluminum coagulants of varying basicity were tested from <10% to almost 50% basicity. There was a strong correlation between coagulant basicity and residual iron concentration following bench scale treatment, whereby each coagulant was dosed to produced water at ranges from zero to 1000 ppmv, followed by pH neutralization, hydrogen peroxide dosing and flocculation of particles using anionic polyacrylamide flocculant.

The effect of low basicity aluminum coagulant dosing was further studied by varying the amount of 9.95% basicity aluminum coagulant, monitoring the residual friction reducer concentration and molecular weight along with residual chelated iron concentration. The results are summarized in Table 2:

TABLE 2
Varying dosage of 9.95% basicity aluminum coagulant

| | Supernatant | | Dosage of | pH | Dosage of | | | | | | |
|---|---|---|---|---|---|---|---|---|---|---|---|
| | taken | | aluminum | after | 1N NaOH to | | Dosage of | | | Residual | |
| Test | from Jar | pH | coagulant | coagulant | get to pH | | peroxide | Dosage of | final | Iron | Polymer |
| Jar | # | initial | (ppm) | dosage | 7.5 | pH | (ppmv) | flocculant | pH | (mg/L) | concentration |
| 1 | 4 | 7.393 | 0 | NA | NA | 7.393 | 80 | 10 | 7.393 | 8.32 | same as |
| | | | | | | | | | | | before |
| 2 | 4 | 7.303 | 300 | 5.371 | 0.2 | 7.532 | 80 | 10 | 7.532 | 7.74 | half |
| 3 | 4 | 7.396 | 600 | 4.663 | 0.5 | 7.48 | 80 | 10 | 7.51 | N.D. | less than |
| | | | | | | | | | | | 100k MW |

The residual polymer concentration and relative molecular weight is shown in FIG. 10B.

Furthermore, the residual dissolved aluminum concentration (passing through 0.45-micron filter) was also tracked under varying coagulant dosage, shown in FIG. 10C. Under the condition of 20 mg/l Al³⁺ dosage, the dissolved aluminum concentration is observed to significantly exceed the aluminum saturation concentration under neutral pH conditions, indicating that aluminum is chelating with residual AMPS co-polymer. Furthermore, once the ‘break point’ aluminum dosage is achieved, the residual chelated iron and aluminum concentrations both decrease to near zero, indicating charge neutralization of the residual AMPS co-polymer may have occurred, with either co-precipitation of the AMPS co-polymer and aluminum, or co-precipitation of the polymer and aluminum and release of complexed iron.

### 2: Friction Reducer Polymer Thermal Degradation

As alternative to chemical treatment of AMPS co-polymer contaminated produced water at surface conditions using aluminum coagulant dosing, thermal degradation of high MW polymer without the use of any breaker was evaluated at reservoir temperature. For these reactions, the following procedure was followed:
a. Produced water from “A” well was treated (as described in experiment 1) to remove dissolved iron from it. After treatment, <5 mg/L dissolved iron produced water sample was obtained.
b. 1 L/m³ AMPS co-polymer was added to 1000 mL of produced water stripped of iron in one beaker and 3 L/m³ AMPS co-polymer was added to another 1000 mL beaker of iron-stripped produced water.
c. These solutions were held in a water bath at 70° C. for 25 days.
d. After five days, both beakers were dosed with ferric chloride, equivalent to 60 mg/L as Fe.
e. HPLC SEC was conducted for the produced water sample periodically at 5 days, 12 days, 17 days, and 25 days to map the reduction of high MW at the end of 25 days.
f. The final produced water solution was treated for iron removal (described in experiment 1) to measure the amount of dissolved iron at the end of 25 days attributable to the reduction of high MW polymers, thus preventing iron chelation, and causing easy floc formation and removal of iron.

Table 3 shows the result of the thermal degradation of polymers. It was observed that at higher AMPS co-polymer loading, more residual polymer was left in solution, resulting in more chelated iron presence, as expected. When the PW+AMPS co-polymer solution was treated for iron removal, 0 mg/L Fe was found post 4 weeks at 70° C. with 1 L/m³ AMPS co-polymer, whereas 10 mg/L of Fe was in solution after 4 weeks at 70° C. with 3 L/m³ AMPS co-polymer, indicating the AMPS co-polymer iron chelation was insignificant at low loading under ideal conditions. 98.3% MW reduction in polymer was observed in samples containing 1 L/m³ AMPS co-polymer at the end of 25 days, whereas 87.3% MW reduction was observed in samples containing 3 L/m³ AMPS co-polymer.

TABLE 3
Thermal Degradation of polymer (No breaker)

| | | Number | | | Residual |
|---|---|---|---|---|---|
| | | of days | | Residual friction | chelated |
| | | at test | Temp. | reducer loading | iron |
| No. | Sample Composition | condition | (° C.) | (L/m3) | (mg/L) |
| 1 | PW + 1 L/m³ AMPS co-polymer | 5 | RT | 0.98 | |
| 2 | PW + 1 L/m³ AMPS co-polymer | 5 | 70 | 1.1 | |
| 3 | PW + 1 L/m³ AMPS co-polymer | 12 | 70 | 0.82 | |
| 4 | PW + 1 L/m³ AMPS co-polymer | 17 | 70 | 0.42 | |
| 5 | PW + 1 L/m³ AMPS co-polymer | 25 | 70 | 0.34 | 0 mg/L |
| 6 | PW + 3 L/m³ AMPS co-polymer | 5 | 70 | 2.96 | |
| 7 | PW + 3 L/m³ AMPS co-polymer | 12 | 70 | 2.32 | |
| 8 | PW + 3 L/m³ AMPS co-polymer | 17 | 70 | 2.02 | |
| 9 | PW + 3 L/m³ AMPS co-polymer | 25 | 70 | 2.26 | 10 mg/L |

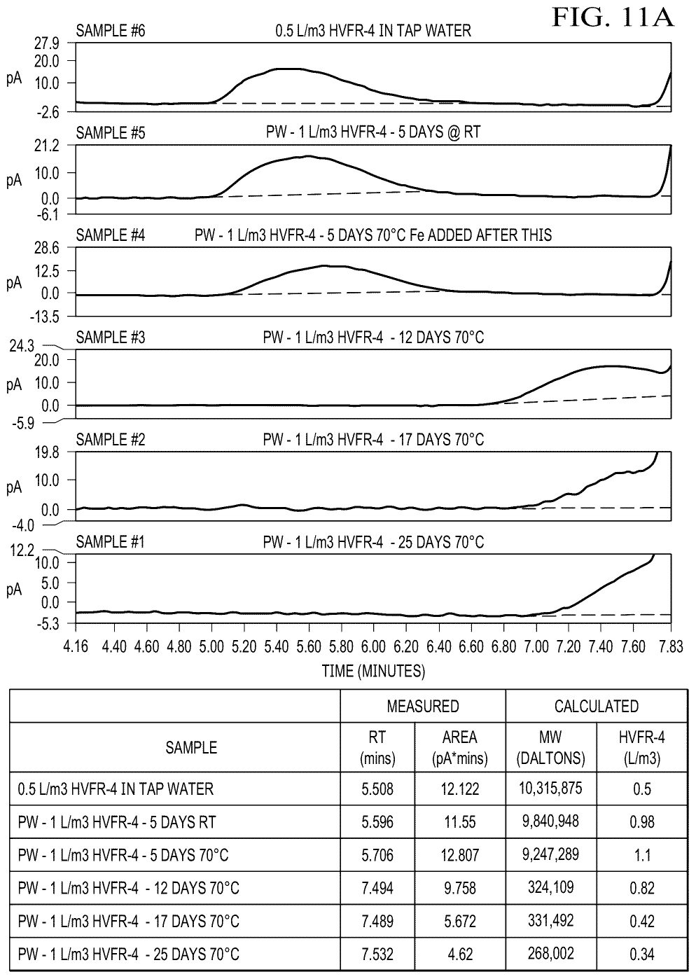

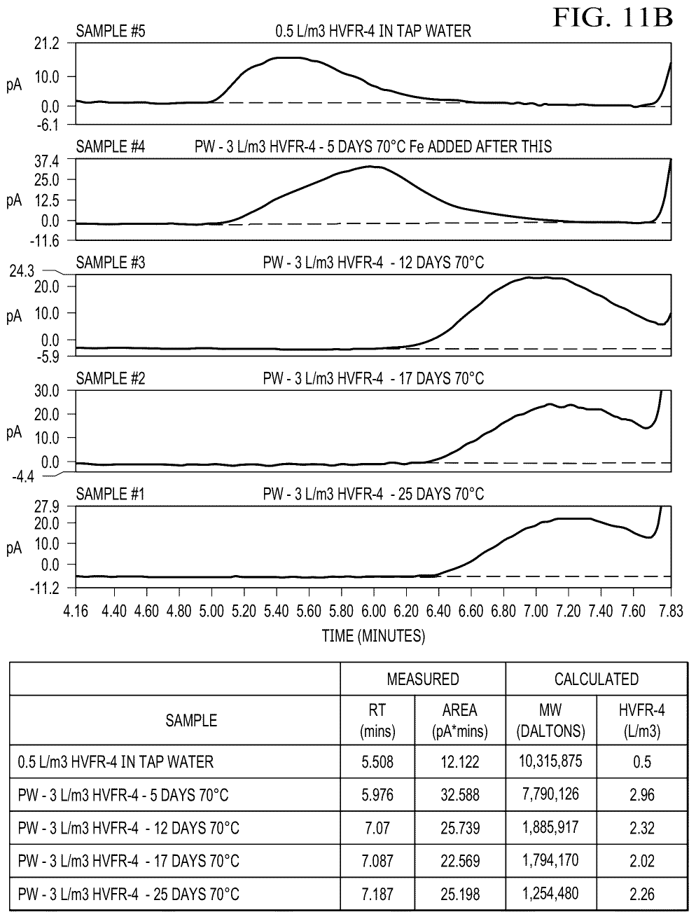

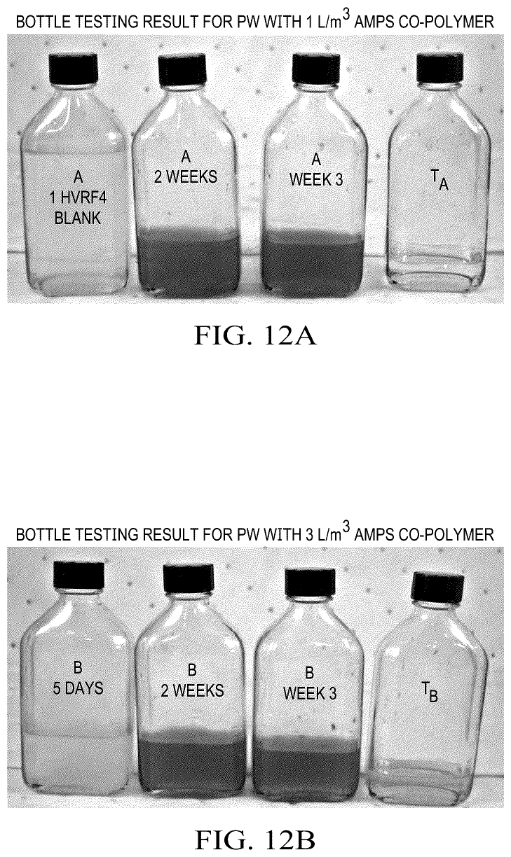

HPLC trace of each of the samples 1-9 in Table 3 is presented in FIG. 11A-B. Bottle test results for the samples with 1 L/m³ and 3 L/m³ AMPS co-polymer samples are shown in FIG. 12A and FIG. 12B, respectively. Interestingly, immediately following dosage of ferric chloride, a significant change in residual polymer MW was observed for all experiments, indicating that the presence of iron in solution or sudden lowering of fluid pH may result in polymer MW reduction. Further testing performed by adding iron to solution by near neutral pH dissolution of steel in the absence of oxygen showed a similar reduction in polymer MW, indicating that presence of iron, rather than pH, is the key driver for the shift in polymer MW.

### 3: Friction Reducer Polymer Thermal Degradation (with Breaker)

Static breaker testing was also carried out. Produced water from “A” well was used after removal of all iron from it, in a procedure as described in experiment 2. The iron free produced water was dosed with AMPS copolymer and a variety of oxidant breaker chemistries to study the impact of oxidant addition on the reduction of polymer MW and ability to eliminate iron chelation. The breakers were chosen from sodium perborate, ammonium persulfate and stabilized 7% H₂O₂ solution. The breaker concentration was added at 0.06 to 0.144 kg/m³ of total volume of solution. This solution was held in a water bath at 70° C. for 25 days.

The addition of ferric chloride may artificially accelerate polymer degradation as shown in experiment 2, thus after the solutions were allowed to rest at 70° C. for the first 5 days, 60 mg/L of ferric chloride as Fe was slowly added. SEC-HPLC was conducted after 5 days (prior to adding any ferric chloride), 12 days, 17 days, and 25 days of the start of the experiment.

The data from the static tests with 0.1 kg/m³ sodium perborate breaker is presented in Table 4. 98.8% polymer MW reduction was observed in solutions with 1 L/m³ AMPS co-polymer samples. With 3 L/m³ AMPS co-polymer, 87.3% polymer MW reduction was observed.

TABLE 4
Thermal Degradation of polymer (With
breaker - 0.1 kg/m³ of sodium perborate)

| | | | | Residual |
|---|---|---|---|---|
| | | | | friction |
| | | No. of days | | reducer |
| Sam- | | at test | Temp | loading |
| ple | Composition | condition | (° C.) | (L/m3) |
| 1 | PW + 1 L/m³ AMPS co-polymer | 5 | 70 | 1.54 |
| 2 | PW + 1 L/m³ AMPS co-polymer | 12 | 70 | 0.39 |
| 3 | PW + 1 L/m³ AMPS co-polymer | 17 | 70 | 0.69 |
| 4 | PW + 1 L/m³ AMPS co-polymer | 25 | 70 | 0.56 |
| 5 | PW + 3 L/m³ AMPS co-polymer | 5 | 70 | 3.82 |
| 6 | PW + 3 L/m³ AMPS co-polymer | 12 | 70 | 0.59 |
| 7 | PW + 3 L/m³ AMPS co-polymer | 17 | 70 | 2.78 |
| 8 | PW + 3 L/m³ AMPS co-polymer | 25 | 70 | 3.43 |

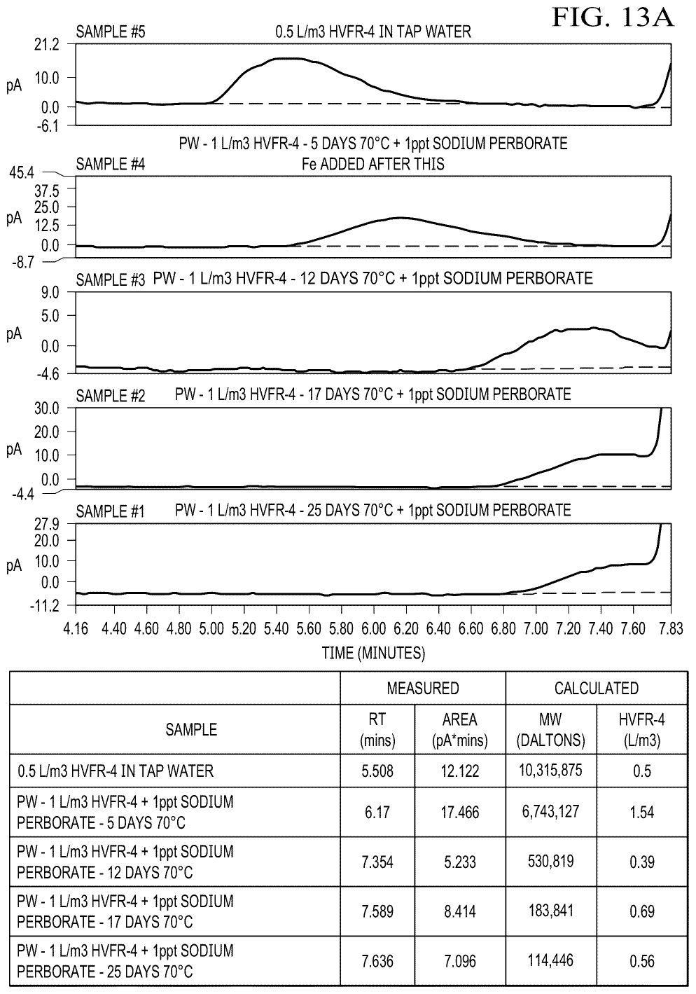

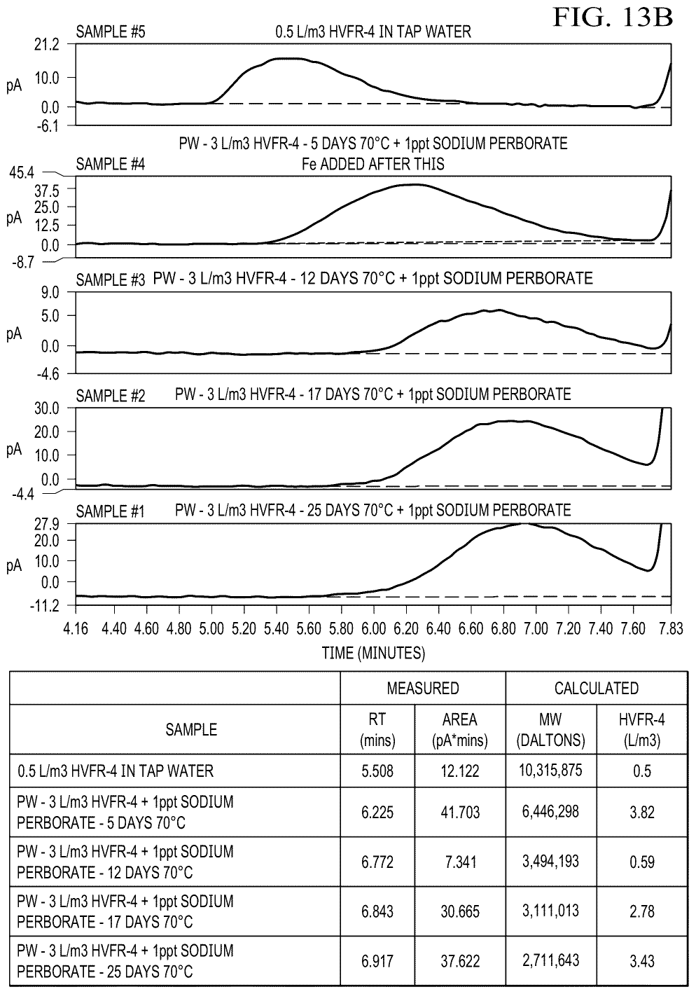

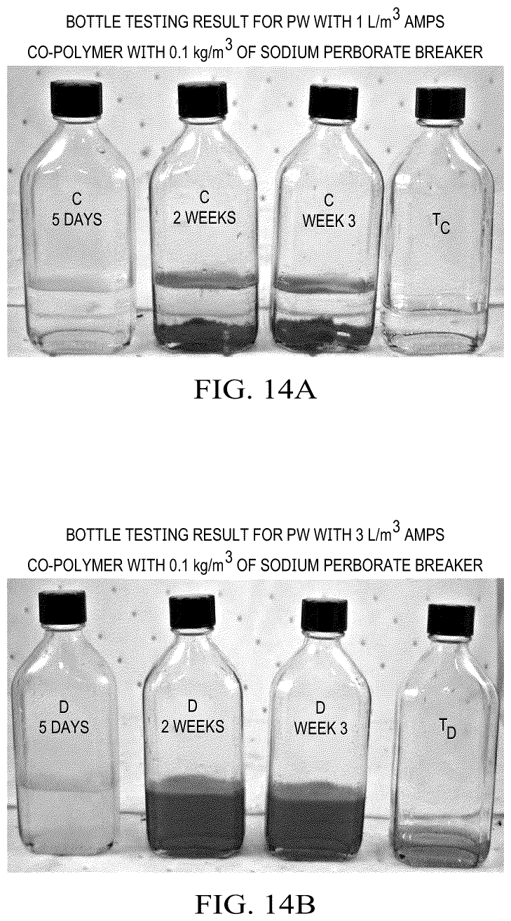

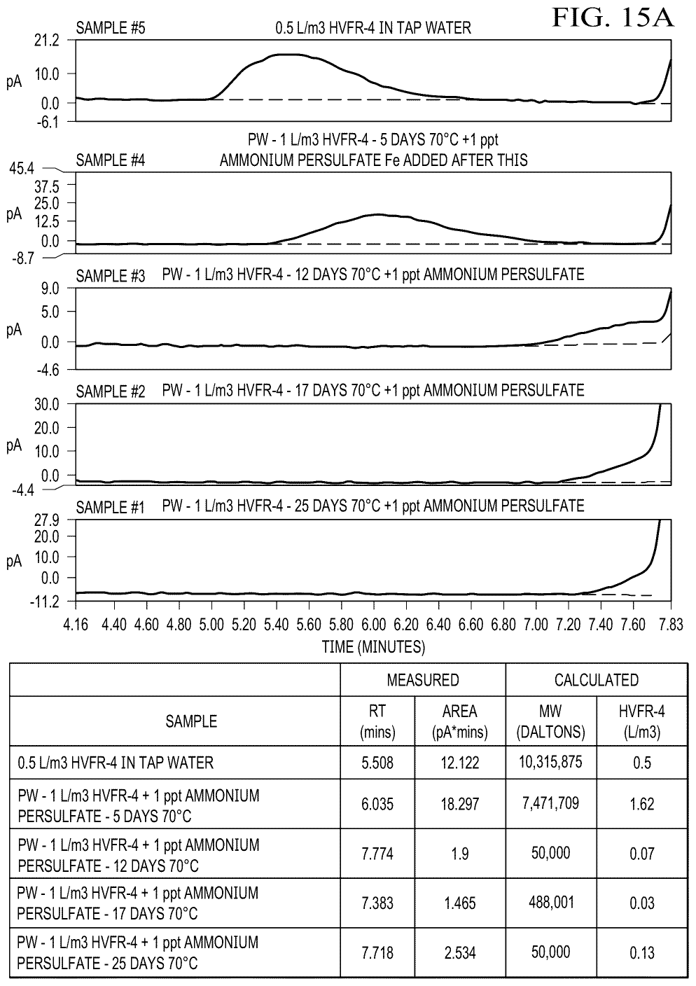

FIG. 13A-B presents the HPLC trace for samples from Table 4 showing reduction of high MW polymer over time. In samples containing 1 L/m³ AMPS co-polymer, 0 mg/L Fe was observed after iron treatment at the end of 25 days. In samples containing 3 L/m³ AMPS co-polymer, 34 mg/L residual Fe was observed post treatment after 25 days. Polymer and iron precipitation and settling out at low polymer loading was more efficient. Excessive chelation of iron was found at high concentration of high MW polymers, as expected. Bottle test results for sample with 1 L/m³ AMPS co-polymer and 3 L/m³ AMPS co-polymer is shown in FIGS. 14A and 14B, respectively.

The static tests with breaker were repeated using 0.1 kg/m³ ammonium persulfate. The data for the tests with ammonium persulfate breaker is presented in Table 5. With low MW loading experiments, no iron was observed at the end of 4 weeks at 70° C. post treatment. No iron was found for samples containing higher loading of AMPS co-polymer polymers as well, indicating effective elimination of iron chelation at both 1 L/m³ and 3 L/m³ polymer loading. Ammonium persulfate was thus found to be more efficient for higher polymer loading for breakdown of polymer and removal of iron by chelation.

TABLE 5
Thermal Degradation of polymer (With
breaker - 0.1 kg/m³ ammonium persulfate)

| | | | | Residual |
|---|---|---|---|---|
| | | | | friction |
| | | No. of days | | reducer |
| Sam- | | at test | Temp | loading |
| ple | Composition | condition | (° C.) | (L/m3) |
| 1 | PW + 1 L/m³ AMPS co-polymer | 5 | 70 | 1.62 |
| 2 | PW + 1 L/m³ AMPS co-polymer | 12 | 70 | 0.07 |
| 3 | PW + 1 L/m³ AMPS co-polymer | 17 | 70 | 0.03 |
| 4 | PW + 1 L/m³ AMPS co-polymer | 25 | 70 | 0.13 |
| 5 | PW + 3 L/m³ AMPS co-polymer | 5 | 70 | 3.51 |
| 6 | PW + 3 L/m³ AMPS co-polymer | 12 | 70 | 0.18 |
| 7 | PW + 3 L/m³ AMPS co-polymer | 17 | 70 | 1.23 |
| 8 | PW + 3 L/m³ AMPS co-polymer | 25 | 70 | 1.35 |

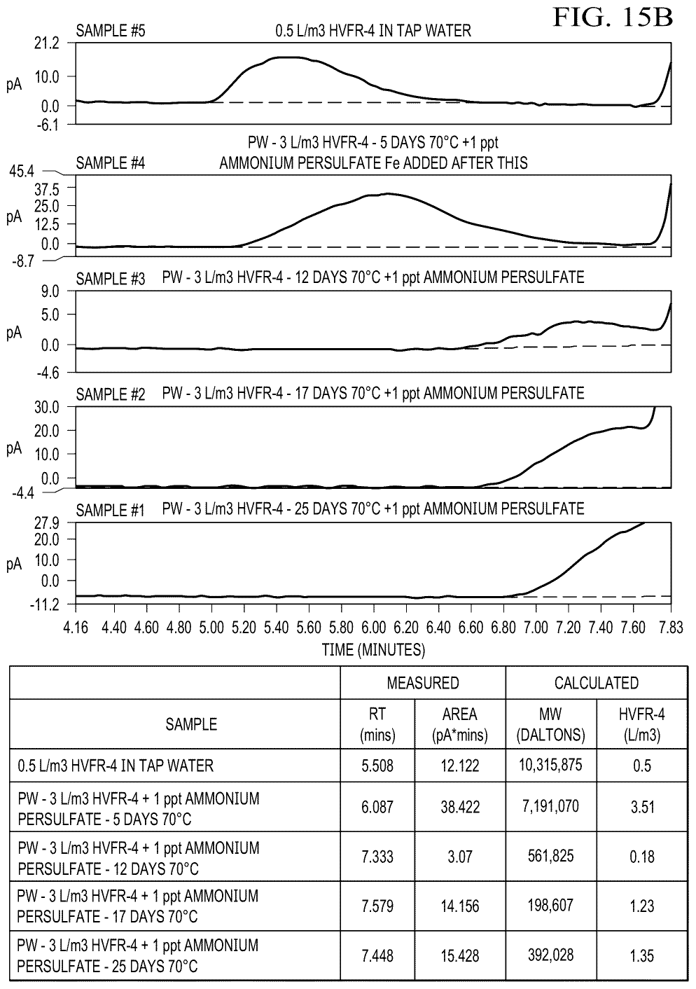

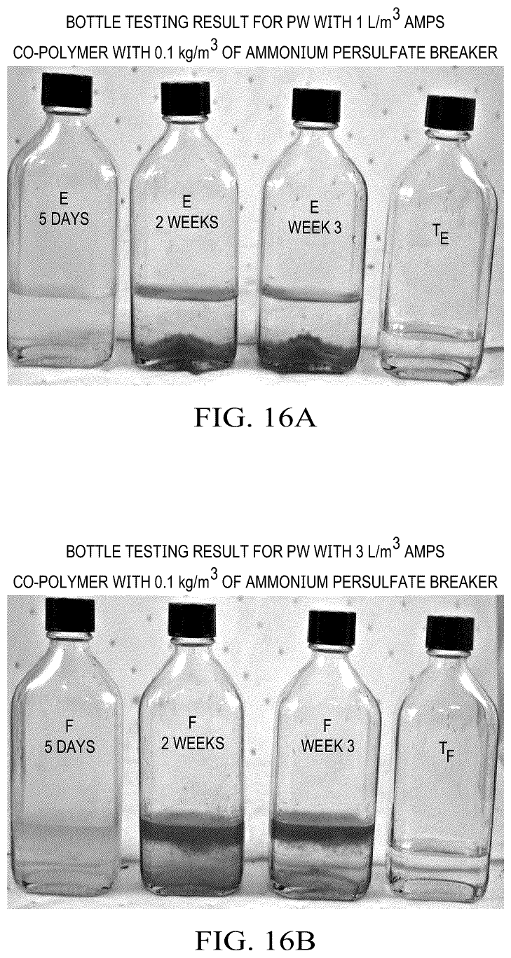

The HPLC trace for samples in Table 5 is presented FIG. 15A-B for 1 L/m³ and 3 L/m³ AMPS co-polymer polymer loading, respectively. Bottle test result after iron treatment showing clear produced water for both 1 L/m³ and 3 L/m³ AMPS co-polymer polymer loading is shown in FIGS. 16A and 16B.

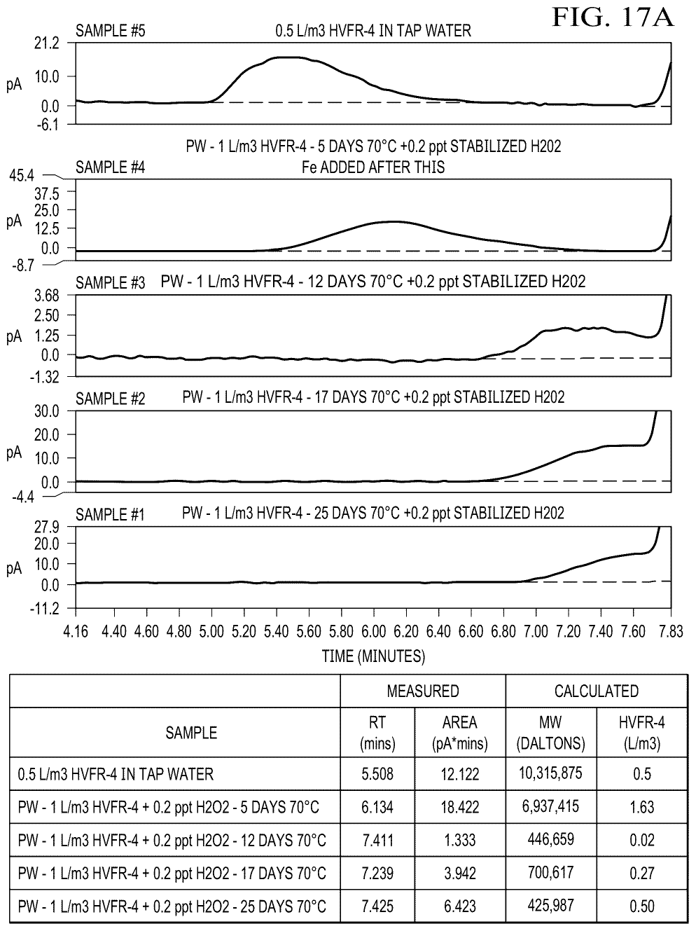

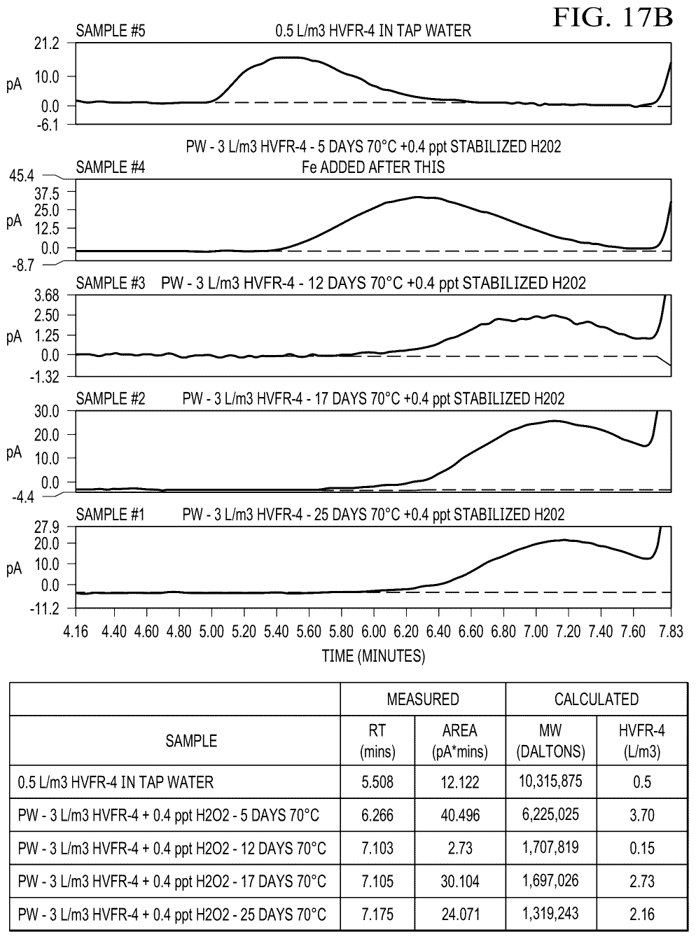

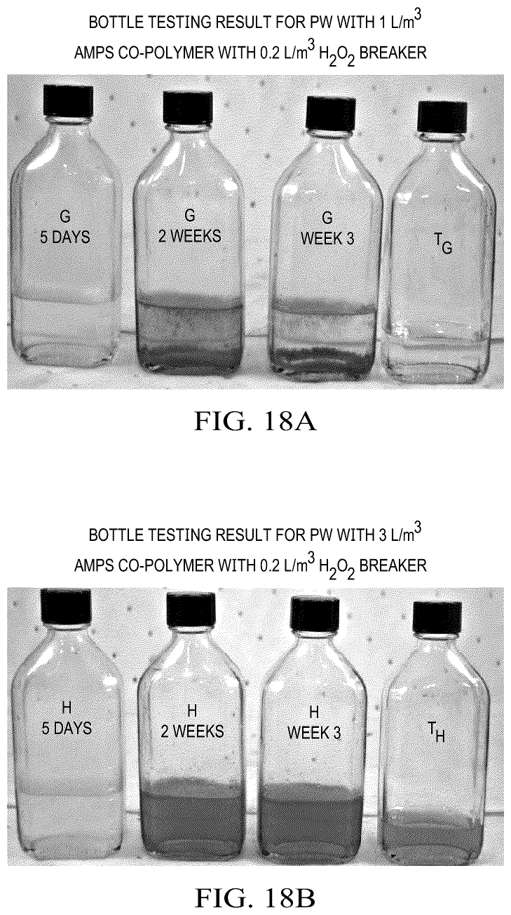

The static tests with breaker were also conducted with 0.2 L/m³ H₂O₂ solution, results of which are presented in Table 6 below. 95.7% reduction in MW was observed with 1 L/m³ HVFR loaded samples, and a MW reduction of 96.6% for 3 L/m³ HVFR loaded samples. The HPLC trace is shown in FIG. 17A-B. The PW after treatment was found to contain 0 mg/L dissolved iron after 25 days in samples with 1 L/m³ HVFR, and 33 mg/L chelated iron was found in samples with 3 L/m³ HVFR. At higher polymer loading, the performance of the H₂O₂ breaker was poor. The bottle tests also shown in FIGS. 18A and 18B display suspended solids in the PW with low and high polymer loading making the use of H₂O₂ breaker less preferred.

TABLE 6
Thermal Degradation of polymer (With breaker - 0.2 L/m³ H₂O₂)

| | | | | Residual |
|---|---|---|---|---|
| | | | | friction |
| | | No. of days | | reducer |
| Sam- | | at test | Temp | loading |
| ple | Composition | condition | (° C.) | (L/m3) |
| 1 | PW + 1 L/m³ AMPS co-polymer | 5 | 70 | 1.63 |
| 2 | PW + 1 L/m³ AMPS co-polymer | 12 | 70 | 0.02 |
| 3 | PW + 1 L/m³ AMPS co-polymer | 17 | 70 | 0.27 |
| 4 | PW + 1 L/m³ AMPS co-polymer | 25 | 70 | 0.50 |
| 5 | PW + 3 L/m³ AMPS co-polymer | 5 | 70 | 3.70 |
| 6 | PW + 3 L/m³ AMPS co-polymer | 12 | 70 | 0.15 |
| 7 | PW + 3 L/m³ AMPS co-polymer | 17 | 70 | 2.73 |
| 8 | PW + 3 L/m³ AMPS co-polymer | 25 | 70 | 2.16 |

A comparison of residual iron present with different breakers used is shown in Table 7. From the tabulated result, it can be inferred that at low concentration of polymer, improved degradation of polymer was achieved with all breakers as well as in thermal degradation test without a breaker. Ammonium persulfate performed well in reducing high MW polymer at both low and high polymer loading, with clear supernatant after treatment. H₂O₂ was the least preferred breaker for this application, as the resulting supernatant after treatment for iron was hazy for both low and high MW polymer loading.

TABLE 7
Thermal Degradation of polymer - Comparison of
breakers post treatment after 25 days at 70° C.

| | | | | Fe conc | |
|---|---|---|---|---|---|
| | | | MW | (mg/L) | |
| | | Breaker | Reduction | post | |
| Sample | Composition | used | (%) | treatment | Supernatant |
| 1 | PW + 1 L/m³ AMPS co-polymer | No | 97.3 | 0 | Clear |
| 2 | PW + 1 L/m³ AMPS co-polymer | Sodium | 98.8 | 0 | Clear |
| | | perborate | | | |
| 3 | PW + 1 L/m³ AMPS co-polymer | Ammonium | 99.5 | 0 | Clear |
| | | persulfate | | | |
| 4 | PW + 1 L/m³ AMPS co-polymer | H₂O₂ | 95.7 | 0 | Hazy |
| 5 | PW + 3 L/m³ AMPS co-polymer | No | 87.3 | 10 | Hazy |
| 6 | PW + 3 L/m³ AMPS co-polymer | Sodium | 87.3 | 34 | Hazy |
| | | perborate | | | |
| 7 | PW + 3 L/m³ AMPS co-polymer | Ammonium | 96.1 | 0 | Clear |
| | | persulfate | | | |
| 8 | PW + 3 L/m³ AMPS co-polymer | H₂O₂ | 96.6 | 33 | Hazy |

### 4: Friction Flow Loop Testing

Friction flow loop testing was performed to assess the impact of oxidant addition on polymer friction reduction performance from ambient temperature to downhole conditions. This testing is necessary as excessive polymer degradation at surface conditions may result in poor friction reduction, increasing wellhead pressures and limiting fluid rates during hydraulic fracturing.

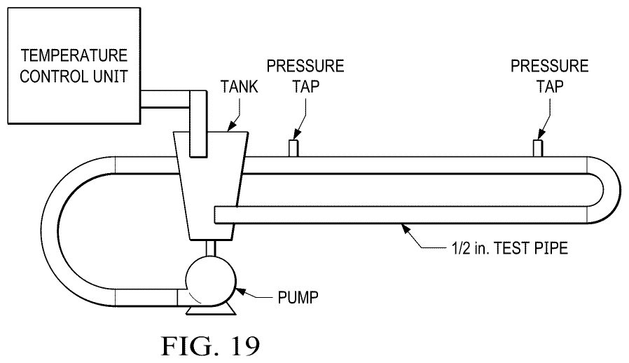

Ideally, the breaker would be inactive until the hydraulic fracturing fluid has flowed through the wellbore and placed the proppant into the rock fractures. Sodium perborate and sodium persulfate breakers were used along with AMPS co-polymer friction reducer to simulate formation conditions in terms of friction and shear provided during downhole fluid movement. A benchtop miniloop instrument with 0.18-inch inner diameter loop was used, with an initial high shear rate held for 12 minutes to represent fluid flowing down the wellbore, and a further 10 minutes at lower shear rate to represent fluid flow through rock fractures. A typical benchtop miniloop is shown in FIG. 19. The parameters used were:

Total cycle time: 22 min
i. 0-12 min at 7.0 L/min, shear rate 12,470 sec⁻¹
ii. 12-22 min at 3.5 L/min, shear rate 6,182 sec⁻¹

The following polymer mixtures were tested in the miniloop with treated produced water from the “A” well:
i. 1 L/m³ AMPS co-polymer
ii. 1 L/m³ AMPS co-polymer+0.05 kg/m³ sodium perborate
iii. 1 L/m³ AMPS co-polymer+0.1 kg/m³ sodium perborate
iv. 1 L/m³ AMPS co-polymer+0.05 kg/m³ sodium persulfate
v. 1 L/m³ AMPS co-polymer+0.1 kg/m³ sodium persulfate

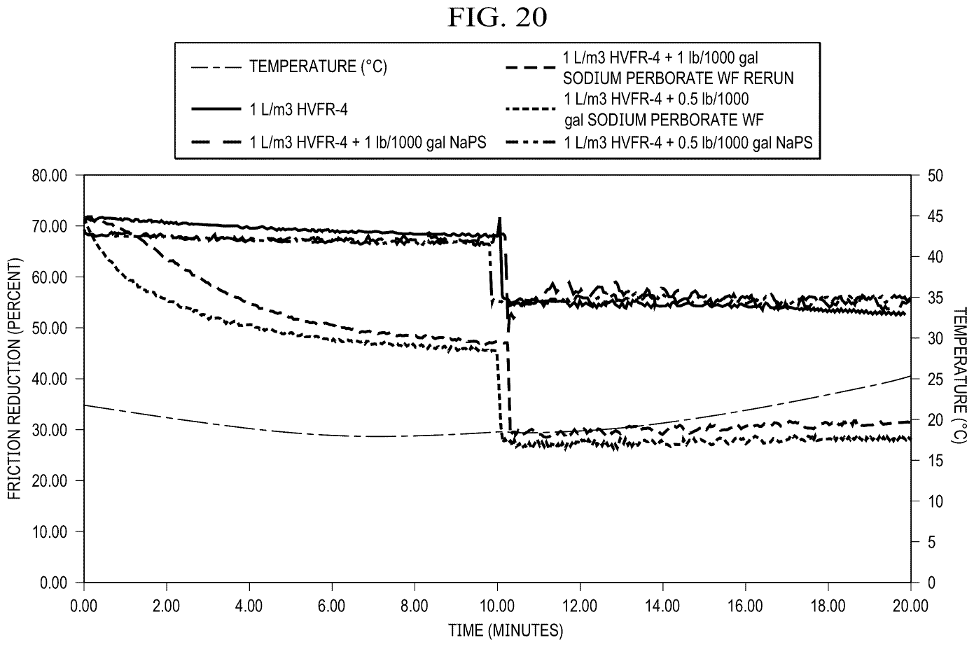

The flow loop result is shown in FIG. 20. The results indicated that the performance of the AMPS co-polymer with sodium perborate breaker at 0.05 and 0.1 kg/m³ with 1 L/m³ AMPS co-polymer showed steady rapid drop within a minute of the start of the flow loop test. With sodium persulfate breaker, the performance decline in the friction reducer was slower and remained insignificant until the fluid temperature reached 25° C.

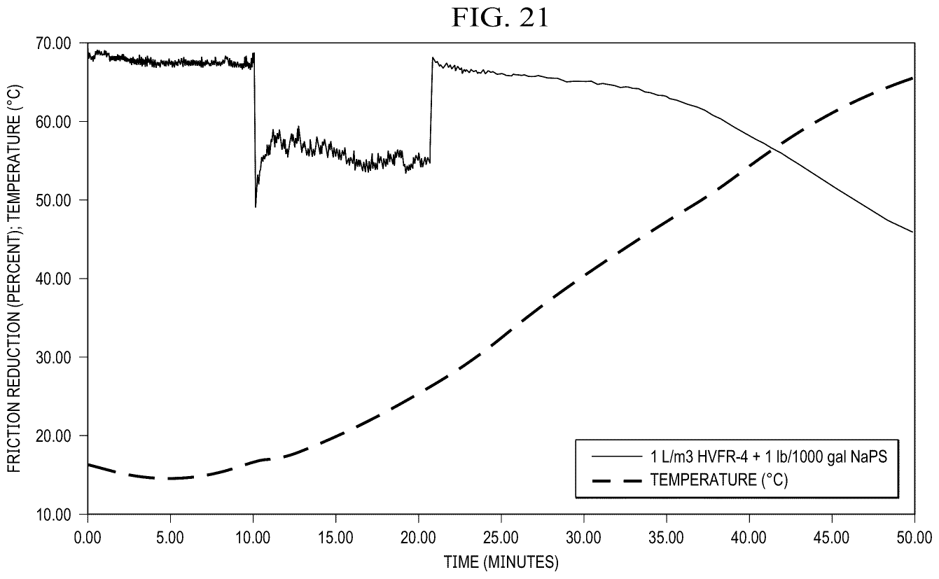

Another test was performed using sodium persulfate oxidant, with a temperature ramp to study the impact of fluid warming as it exchanges heat with the higher temperature rock downhole. The results are shown in FIG. 21. No significant difference in performance of the FR was observed at 0.05 and 0.1 kg/m³ dose rates of sodium persulfate.

In summary, oxidant addition was found to be effective for polymer degradation at reservoir conditions (˜70° C.) in the presence of iron. Persulfate type oxidants were found to be most effective for polymer degradation, whilst preventing degradation of friction reduction performance at low temperatures (<45° C.) expected during high friction loss flow down the wellbore and proppant placement. The use of oxidant ‘breaker’ for completions is not new, however its use to target water treatability and prevention of iron chelation is novel, as are the tests to confirm both chelation and/or elimination of chelation on sufficient treatment.

Furthermore, the use of aluminum compounds for surface treatment of produced water contaminated with residual high molecular weight anionic polymer friction reducer is a novel, feasible and effective approach for treating this problem.

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
U.S. Ser. No. 11/072,546 Decomplexation of chelated hardness at high pH.
Sharma, R. R.; Bjornen K. “Systematic Approach for developing a “fit-for-purpose” treatment for produced water reuse in hydraulic fracturing.” (2018) Paper presented at the Unconventional Resources Technology Conference, Houston.
Walsh, J. M.; Bansal, K. M. “A reassessment of the role of colloidal iron in produced water from shale operations—A review of field data and literature (Part A).” (2021) Oil and Gas Facilities, Journal of Petroleum Technology, Sep. 20, 2021.
Carman, P. S.; Cawiezel, K. “Successful breaker optimization for polyacrylamide friction reducers used in slickwater fracturing.” (2007) Paper presented at the SPE Hydraulic Fracturing Technology Conference, College Station, Texas, U.S.A. Paper Number: SPE-106162-MS.
Product Brochure: Nouryon (Unknown date). “New high-performing scale inhibitor and dispersing agent with low free monomer levels.

1. A method of cleaning produced water from a reservoir, said method comprising:
a) testing a water produced from a hydrocarbon reservoir (“produced water”) to confirm that iron is chelated by a high molecular weight (“MW”) polymer in said produced water, and if so treating said produced water having polymer chelated iron at a temperature of 55° C. or greater with an amount of an oxidant for a period of time sufficient to convert said polymer to polymer remnants that no longer chelate iron and producing free iron;
b) oxidizing said free iron by neutral pH oxidation; and
c) removing said polymer remnants and said iron to produce cleaned produced water.

2. The method of claim 1, wherein said oxidant is selected from the group consisting of H₂O₂, sodium persulfate, ammonium persulfate, sodium perborate, or combinations thereof.

3. The method of claim 1, wherein said oxidant is sodium- or ammonium-persulfate.

4. The method of claim 1, wherein step b is performed downhole.

5. The method of claim 1, wherein step b is performed at the surface.

6. The method of claim 1, wherein said high molecular polymer is selected from the group consisting of acrylamido-methylpropane sulfonate polymer (AMPS), polyacrylamide (PAM), polyacrylic acid (PAA) and partially hydrolyzed polyacrylamide (PHPA), or copolymers thereof.

7. The method of claim 1, wherein said high MW polymer is AMPS or copolymers thereof.

8. The method of claim 1, further comprising step b2, repeating said testing step a) to confirm that at least 80% of said high MW polymer is converted to polymer remnants before proceeding to step c, and if less than 80% is converted, then increasing said period of time, said temperature, said amount, or combinations thereof.

9. The method of claim 1, wherein said oxidant is sodium- or ammonium-persulfate, said polymer is AMPS, and said temperature is at least 70° C.

10. The method of claim 1, wherein said removal step c) methodology is selected from one or more of precipitation, flotation, centrifugation, decantation, filtration, or combinations thereof.

11. A method of cleaning produced water, comprising:
a) treating a produced water having iron-polymer chelates with an aluminum compound at surface conditions to free iron;
b) oxidizing said free iron by neutral pH oxidation; and
c) removal of said oxidized iron to produce cleaned produced water.

12. The method of claim 11, wherein said aluminum compound is selected from the group consisting of polyaluminum chloride, aluminum chlorohydrate, and polyaluminum sulfate.

13. The method of claim 11, wherein said aluminum compound is polyaluminum chloride, and the pH is maintained at pH 7.0+/−0.25.

14. The method of claim 11, wherein said polymer in iron-polymer chelates is selected from the group consisting of acrylamido-methylpropane sulfonate polymer (AMPS), polyacrylamide (PAM), polyacrylic acid (PAA) and partially hydrolyzed polyacrylamide (PHPA), or copolymers thereof.

15. The method of claim 11, wherein said polymer in iron-polymer chelates is AMPS or copolymers thereof.

16. The method of claim 11, further comprising a pre-testing step i) to confirm that said produced water has iron-polymer chelates.

17. The method of claim 11, further comprising a post-testing step b2) to confirm that said at least 80% of iron is free iron.

18. The method of claim 11, wherein said removal step c) methodology is selected from one or more of precipitation, flotation, centrifugation, decantation, filtration, or combinations thereof.

19. A method of hydraulic fracturing, comprising:
a) testing a polymer suitable for use in hydraulic fracturing to determine said polymer will chelate iron;
b) testing an oxidant for said polymer to determine if it will degrade said polymer at reservoir temperatures to form polymer fragments that will not chelate iron;
c) fracturing a reservoir with a hydraulic fracturing fluid comprising water, said polymer and said oxidant;
d) waiting a period of time to degrade said polymer to polymer fragments that no longer chelate iron;
e) producing oil and water from said reservoir and separating said produced oil from produced water;
f) optionally testing said produced water to confirm that iron is free iron, and if a portion of said iron remains chelated, adding more oxidant to further degrade said polymer;
g) treating said produced water to oxidize free iron by neutral pH oxidation; and
h) removal of said oxidized free iron.

20. The method of claim 19, wherein said removal step h) methodology is selected from one or more of precipitation, flotation, centrifugation, decantation, filtration, or combinations thereof.

21. A method of hydraulic fracturing, comprising:
a) fracturing a reservoir with a hydraulic fracturing fluid comprising water and a polymer that can form iron-polymer chelates;
b) producing oil and water from said reservoir and separating said produced oil from produced water;
c) treating said produced water having iron-polymer chelates with an aluminum compound to form free iron;
d) treating said produced water to oxidize free iron by neutral pH oxidation; and
e) removal of said oxidized free iron.

22. The method of claim 11, wherein said aluminum compound is selected from the group consisting of polyaluminum chloride, aluminum chlorohydrate, and polyaluminum sulfate.

23. A method of cleaning produced water, comprising:
a) treating a produced water that has been determined to have iron-polymer chelates with either an aluminum compound at surface conditions to free iron or an oxidant at a temperature of at least 55° C. to free iron;
b) oxidizing said free iron by neutral pH oxidation; and
c) removal of said oxidized iron to produce cleaned produced water.
